(19) United States
(12) Patent Application Publication
(10) Pub. No.: US 2003/0141155 A1
(43) Pub. Date: Jul. 31, 2003

(54) Industrial robot with an actuated brake system, which cooperate with the robot's control system

(76) Inventors: Anders Daneryd, Vasteras (SE); Bo Holmgren, Vasteras (SE); Malin Akermo, Taby (SE); Olle Winroth, Vasteras (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/203,427

(22) PCT Filed: Feb. 6, 2001
(86) PCT No.: PCT/SE01/00155

(30) Foreign Application Priority Data
Feb. 23, 2000 (SE) 0000606-4

(51) Int. Cl. F16F 9/53

(52) U.S. Cl. 188/267.1

(57) ABSTRACT

A permanent magnet brake system consists of a first body with an active area and a second body with an active area. Between the first and the second active area is a fluid. The fluid activates with a magnetic field when the brake is activated.

### TECHNICAL AREA

The present invention concerns an industrial robot with a brake system, a method for the robot and the use of the robot.

### BACKGROUND

An industrial robot comprises a number of robot parts, which are movable relative to each other. Movements are normally provided by electric motors. The motion is accelerated and retarded during one working cycle by regulating the speed of the motor. Retardation during normal use currently takes place solely by the use of motors. Each joint is equipped with a brake in order to achieve sufficient braking power or torque and for emergency braking with or without the aid of motors and computers. The brake also has the task of holding the load static.

The action of the brake may be either dynamic or static. A dynamic brake produces a dynamic retardation torque, and will be referred to by “brake” in this document. A static brake produces a static torque and will be referred to by “holding brake” in this document. The functions of a brake and a holding brake may be obtained as two functions from one component.

Industrial robots have progressively developed during the past 20 years, while the brake, as a component of robots, has in principle remained the same. As the development of the industrial robot has progressed, requirements for the properties of the brake have increased. In spite of this, the situation today is that the brake as a component is not adapted to the requirements of the industrial robot. The brakes that are included in industrial robots today are based on friction, in which the retardation torque is built up from three main parameters: the torque arm, the normal force and the coefficient of friction. The mechanical friction brakes are in principle of two types: spring pressure brakes and permanent magnet brakes. Independently of the type of brake that is used, there are large individual variations between the retardation torque of brakes of the same type. The retardation torque developed by two otherwise identical brakes can differ by a factor of up to two, or greater. Furthermore, the torque produced by an individual brake varies during use, due to wear and heating by the motor. Taken together, these phenomena can lead to disturbances, shutdown, interruptions in service and safety risks associated with a robot.

The development of industrial robots has resulted in robots with high positional accuracy. Today's mechanical brake cannot be influenced and therefore cannot be used as a regulated braking function in a regulator system, but are instead used as a non-controllable function in the event of an emergency. The description “influenceable brake” is defined as a brake that has an infinitely variable retardation torque.

The non-influenceable brakes of today have a large spread of retardation torque, which makes it impossible to follow a definite robot path during an emergency stop with such a brake. Thus, the risk of collision and the risk for deviation from a pathway arise during emergency braking. A brake possible to regulate avoids this problem. The description “regulated brake” is defined as a brake that can be influenced and observed, that is, that a certain measurable property can provide information about the torque in the brake.

Each motor in an industrial robot is equipped with a brake system. The brake system must be able to maintain the robot in an unchanged raised position in the event of a sudden emergency stop, both with and without energy supply. For this reason, a holding brake is included in the control system The holding brake is controlled though direct application or removal of power.

Two types of emergency braking occur in the application of industrial robots. One type is emergency braking with motors and computers. In this case, the brakes produce a torque that is complemented with a motor torque. The motor torque stops the robot and then the brake is instantaneously applied. There is no possibility of observing and influencing the braking action.

In the second type of emergency braking, which occurs, for example, in the event of loss of power, the motor torque disappears and only the torque of the brake can be exploited.

Today's brakes have a directly acting application, which gives a rapid change in the retardation torque. This forces vibrations in the structure of the robot, which leads to increased loads and tensions. The forced vibrations are translated into what are known as “dynamic factors”, which are introduced during dimensioning of the robot. In this way, the robot receives a maximum allowed loading torque, that is, the torque that gives maximum allowed tensions in the structure. Current brakes have variations in the retardation torque, which depends on, for example, variations in the coefficient of friction. This makes it difficult to exploit the maximum allowed loading torque for the robot. Up until now, the solution for this has been partly to overdimension the structure, leading to more solid robot structures, and partly to maintain the retardation torque at a low level, leading to longer distances for stopping.

A brake which can be influenced and in which the retardation torque is applied more gently makes it possible to avoid the excitation of vibrations, and makes it possible to reduce tensions. An influenceable/regulated brake, which makes it possible to exploit the maximum loading torque during the complete retardation phase, makes reductions of the stopping distances and means that the robot does not need to be overdimensioned.

A great deal of power is consumed in the motors during retardation and when holding a load stationary. An influenceable/regulated brake gives a gentle, power saving and rapid retardation to stationary state and can then also hold the load stationary at the end position An influenceable/regulated brake that is independent of the speed of revolution gives a shorter stopping distance. An influenceable/regulated brake provides a completely new pattern of behaviour/movement for the robot that requires less energy and thus reduces energy consumption. Furthermore, relatively larger loads can be managed by such a retardation system.

The lifetime of today's holding brakes is determined by mechanical wear. The friction during the braking can give unwanted noise.

The document WO 98/00649 shows a braking device that contains a magneto-rheological fluid, MR-fluid. Thus, this braking device is called a MR-brake. The MR-fluid is a suspension of magnetisable particles in a fluid. The MR-brake comprises a disk-shaped rotor that is rotatably suspended by the aid of a shaft. The shaft in turn is suspended in bearings in a housing. By sending a current through a winding a variable magnetic field in a coil is created. The MR-fluid is located in the gap between the coil and the rotor (FIG. 14) and when the magnetisable particles are exposed to the magnetic field that is induccd by the current in the coil, the MR-fluid obtains a high yield stress and is experienced, in principle, as solid. In this way, the rotor is stopped and held stationary at its end position. The MR-brake is released when the current is switched off.

The aim with this known MR-brake is to construct a rotating brake that solves the problems of high manufacturing costs, the heavy weight of the brake and wear of sealings due to a high working temperature. The brake is used in training devices such as exercise bicycles.

There has for a long time been a need within the robot industry to increase the performance of the robot, and this has worked well with presently available brakes. New functions have now been added in some robot applications and they are based on increased efficiency and control of the movements of the robot. The control of these movements depends of the possibility of influencing the brake system of the robot. Thus, there has arisen during manufacture and use of industrial robots of the type described above the need for an influenceable/regulated retardation system that can be influenced such that the retardation torque is optimised during a braking process and that also gives full braking effect in the event of power failure.

The retardation devices according to the above-specified document WO 98/00649 cannot satisfy these needs.

### DESCRIPTION OF THE INVENTION

An industrial robot comprises, among other things, manipulators and control systems. A manipulator is defined as the link arms, joints, transmissions and driving means that are part of the mechanical arm/construction. The control system generates movements of the manipulator by servo-control of the individual driving means and generates defined movements by a control- and interpolation model of the physical construction of the manipulator. The description “robot” hereunder concerns an industrial robot system comprising, among other things, a manipulator and control system with regulatory systems according to the definition above. It may also comprise external shafts.

A manipulator comprises a number of robot parts arranged relative to each other. Furthermore, driving means are included that supply movements between the robot parts, brakes and holding brakes as defined above.

The intention of the invention is to arrange on a robot, defined according to the above, a brake system with influenceable/regulated brakes that collaborate with the control system of the robot. The inventive concept is to build up retardation torque from the parameters torque arm, shear force in a medium and active area. This exchange of physical phenomenon, from friction between two surfaces, creates the possibility of significantly reducing variation in the retardation torque of a brake. In this way, the brake power can be used as a parameter in the regulator system and increases both the controllability and the speed of the robot. In summary, such a braking function gives increased control of the retardation torque and thus the robot can be made more slender.

The solution according to the invention is characterised by the industrial robot specified in claim 1, with a driving means comprising a brake system that collaborates with the control system and that is arranged to be influenceable/regulated. The brake system comprises a first body with a first surface and a second body with a second surface, with a medium arranged between the surfaces. The medium transfers power between the bodies when in an active state. In this way, a braking power is transferred when the medium is active.

The solution according to the invention also includes that, during manufacture of an industrial robot, the driving means is caused to comprise a regulated brake system that collaborates with the control system. The brake system is caused to comprise two bodies, each with one surface. A medium is placed between the surfaces of the bodies, which medium transfers when activated a force between the bodies in accordance with the first independent method claim.

The solution according to the invention also includes that the control system of the industrial robot collaborates during driving of the robot with an influenceable/regulated brake system.

The medium is activated by a magnetic field. The magnetic field is caused to comprise a first magnetic field, the magnetic field is caused to comprise a second magnetic field and the first magnetic field is arranged opposite in direction to the second magnetic field. The brake system activates the medium in order to transfer a force in order to brake and bring to an end in a regulated manner the movements of the robot in accordance with the second independent method claim. Furthermore, the invention makes possible an influenceable, rapid and gentle retardation, in that the retardation torque is controlled by the brake system and that magnetic fields are arranged in accordance with the subsidiary claims. Furthermore, the invention provides full brake power in the event of power failure.

The solution according to the invention includes also the use of a medium that in an active condition produces a shear force in order to dynamically stop the movements of an industrial robot and to hold a load stationary at the end position. Furthermore, the invention means the use of a magneto-rheological medium and the use of a MR-brake in accordance with the subsidiary claims.

An industrial robot in accordance with the present invention is equipped with one or several brake systems comprising a medium that produces in an active condition a shear force F in order to dynamically stop the movements of the robot and to hold a load stationary at the end position. The medium is placed between two surfaces that constitute the active area in the brake. The space between the two surfaces forms an active gap when a magnetic field is applied. The brake system comprises a magnetic arrangement whose magnetic field activates the medium. The magnetic arrangement comprises either at least one current-carrying coil whose magnetic field can be varied with the current or at least one permanent magnet or a combination of a coil and a permanent magnet. In one preferred embodiment of the invention the medium is constituted by a MR-fluid.

In one preferred embodiment, a brake system with a coil in accordance with the present invention is arranged such that a current that can be influenced and that passes through the coil induces a magnetic field that activates the medium. The medium is a MR-fluid. The braking effect is influenceable in that the current through the coil is made selectably variable. In this way, the movements of the robot are dynamically stopped through the influenceable brake system. A holding brake is activated at the end position in order to hold the load stationary. The requirement for holding the load stationary in the event of loss of power can be fulfilled by driving the holding brake by reserve power. In one embodiment of the invention, a magnetic field is induced by a current through a MR-brake.

The brake system according to the invention provides a retardation torque that is independent of the speed of revolution and, furthermore, one that is proportional to the applied magnetic field. The latter fact means that the retardation torque can be observed. Furthermore, the brake is contact-free and has a response time that is less than 10 ms.

In another preferred embodiment, it is a brake system with one or several collaborating permanent magnets in accordance with the present invention that activates the medium. The medium is a MR-fluid. By changing the position of the permanent magnet with respect to the medium the braking effect is influenced, that is, the permanent magnet is displaceably arranged in order to make it possible to vary the position of the magnetic field across the medium. In this way, the movements of the robot can be dynamically stopped through an influenceable brake system. The requirement for holding the load stationary in the event of loss of power is fulfilled by the magnetic field of the permanent magnet. The positioning of the permanent magnet relative to the medium should thus be brought about by an external power source, which means that the magnetic field of the permanent magnet activates the MR-fluid and produces a retardation torque that brakes and brings to a stop the movements in the event of loss of power.

According to a further preferred embodiment, there exists a brake system with a combination of coil and permanent magnet in accordance with the present invention, which is based on a passive magnetic field and acts against this field. The permanent magnet produces a magnetic field that activates the medium and thus the brake. An influenceable current through the coil induces a magnetic field that is caused to act against the field from the permanent magnet. The medium is a MR-fluid. The sum of the magnetic fields that act against each other deactivates the medium In one embodiment of the invention, a MR-brake is combined with a permanent magnet device.

In one embodiment of the invention a separate parameter, for example, a sensor, is arranged in the brake system in order to observe the resulting magnetic field, that is, the sum of the magnetic fields that act against each other for a given current into the coil. In this way, the retardation torque that is produced in the brake system can be regulated according to the above-mentioned definition. When the magnetic fields that act against each other are equal in strength, the magnetic field is neutralised and becomes zero. When the current does not flow, the maximum retardation torque is produced from the permanent magnet device and the brake system acts as a holding brake.

During an emergency stop, a certain part of the torque of the brake is used together with the torque that the motors provide. The torque can be applied more gently with a brake system in accordance with the present invention both with and without regulation since the coil possesses an electrical hysteresis in itself. Furthermore, the application of the torque can in a regulated brake be adapted to whether a robot shaft is in a folded or a rigid position, extended or withdrawn. The advantages of this are that the retardation torque can be optimised in order to achieve short brake distances, low stresses on the structure and in order to avoid problems with regulation that may arise due to vibrations.

The inventive concept includes one embodiment with one brake, one embodiment with two brakes, one regulated brake and one passive brake consisting of one or several permanent magnets and one embodiment with two active brakes. The latest embodiment gives a more rapid and a more exact braking action.

The invention according to the above is based on a passive magnetic field and the opposition of this. The inventive concept includes also the variation based on no magnetic field and the building up of an active magnetic field.

The inventive concept also includes an embodiment in which the regulated brake and the motor collaborate, giving an optimal torque. When the brake and the motor are stopped at the same time, the cycle time is shortened. Furthermore, the gearbox is protected from damaging loading. At the same time, the current to the motor and the brake is reduced and in this way the power consumption is reduced.

The inventive concept also includes an embodiment in which the permanent magnet is placed such that its magnetic field is opposite in direction to that of the coil without the permanent magnet being demagnetised, which requires what are known as hard magnets.

The inventive concept also includes an embodiment in which the permanent magnet lies either insulated from the coil or with its field oriented in the same direction, except for in the active gap, where the fields are oriented in opposite directions. This is achieved by that the magnetic field of the permanent magnet and of the coil each passes through an iron core, which iron cores are united over the active gap.

The inventive concept also includes the arranging of the surfaces between which the medium is placed, partly at an angle to each other and partly straight and at an oblique angle to the magnetic field. The properties of the surfaces are a smooth surface, a rough surface structure or a surface structure constructed with depressions in which the medium can be placed.

The inventive concept also includes an embodiment in which the coil and the permanent magnet are arranged around a common line of symmetry.

The brake system should be placed on one of the sides of the motor or on the input shaft to the gearbox. The holding torque becomes more efficient the further forwards in the gearchain that the brake is located. An alternative solution is to build the brake system into the motor. Another alternative is to combine/build together the bearings and the brake.

The brake system according to the present invention makes a reduction of power consumption possible when the robot is to brake towards a point, as will be explained in the following. In order to keep the requirement for torque from the motors in a robot low, balancing is normally introduced on certain shafts. Energy-storing systems are normally used, for example, springs or counter-weights. The advantage of these types of balancing is that they reduce the total torque required from a static point of view. The disadvantage is that they often are bulky and that from a dynamic point of view they can reduce the performance of the robot. This disadvantage is also solved by the use of a regulated brake. A brake unit according to the present invention can be made very small in comparison with conventional balancing devices and it does not influence the acceleration performance of the robot. In this way, the fact that the brake is regulated means that the balancing can be optimised and adapted to all of the loading situations of the robot and not just to one, as is the case for the classical balancing.

The inventive concept also includes an embodiment in which the brake also stops any translational movements.

The inventive concept also includes an embodiment in which the medium is constituted by a fluid, where the designation “fluid” also denotes powder in air.

The inventive concept also includes the embodiment in which the medium is constituted by a fluid that lies in an absorbing matrix, for example, a porous sponge. The need for sealings is reduced in this way.

Any eddy current losses caused by leading the magnetic field through the rotating rotor are reduced in that the part that rotates relative to the permanent magnet is manufactured of a material that inhibits eddy currents, for example, pressed iron powder or laminated, layered magnetic material. A further alternative is to arrange a clutch device that releases the brake system when the motor is active.

This description is not to be seen as a limitation of the invention, but only as a guide to full understanding of the invention Adaptations to robots with other constituent active parts and the replacement of items that are obvious for one skilled in the arts can, of course, be made within the scope of the inventive concept.

### DESCRIPTION OF DRAWINGS

The invention will be explained in more detail by description of an embodiment with reference to the attached drawings, in which:

FIG. 1 shows an industrial robot in accordance with the definition given above,

FIG. 2 shows a brake device-according to the present invention arranged with two permanent magnets, one on each side of a rotor and a sealing to a medium,

FIG. 3 shows a brake device according to FIG. 1 with the sealing working with respect to the rotor,

FIG. 4 shows a brake device according to the invention with a permanent magnet built into a rotor,

FIG. 5 shows a brake device according to the invention with a permanent magnet built into a brake housing and radially oriented between a rotor and a coil.

FIG. 6 shows the brake device according to FIG. 4 in radial cross-section with a ring-shaped permanent magnet arranged coaxially between a rotor and a brake housing, together with a number of axially arranged coils built into the brake housing,

FIG. 7 shows a brake device according to the invention with a rotor and a brake housing in which a number of units with a permanent magnet and a coil are built in at a distance from each other,

FIG. 8 shows a brake device according to the invention with a permanent magnet built into a brake housing and a coil built into a rotor,

FIG. 9 shows a brake device according to the invention with a coil and with what is known as a hard, non-demagnetisable permanent magnet built into the brake housing,

FIGS. 10a, b, c and d show various possible rotors with their equivalent active areas drawn in,

FIGS. 11a, b show a brake device according to the invention with a disc-shaped rotor and a permanent magnet displaceably arranged in a braking and in a non-braking position,

FIG. 12 shows a brake device according to FIG. 10 arranged with an oblique rotor,

FIG. 13 shows a brake device according to FIG. 10 arranged with an oblique rotor,

FIG. 14 shows a MR-brake that comprises the current art.

### DESCRIPTION OF EMBODIMENTS

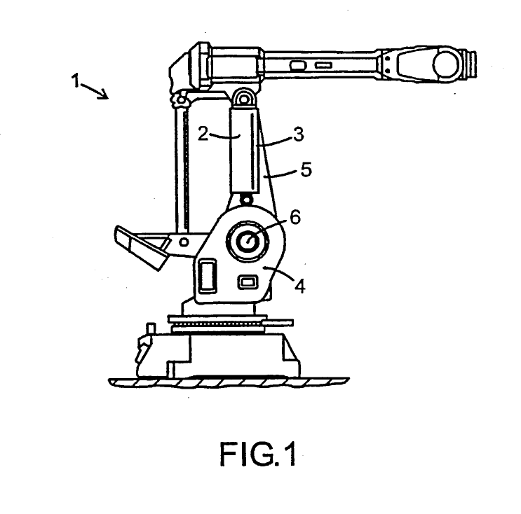

A brake system 7 in an industrial robot 1 (FIG. 1) defined according to the above comprises a rotating shaft 8 equipped with a fixed arranged rotor 9. The brake system 7 is arranged in order to stop a rotational movement that is transferred to the brake via the shaft 8. The shaft 8 is mounted on coaxial bearings in a brake housing 9 divided into two or more parts and with an axis of symmetry 8a The shaft 8 is normally manufactured from magnetic material.

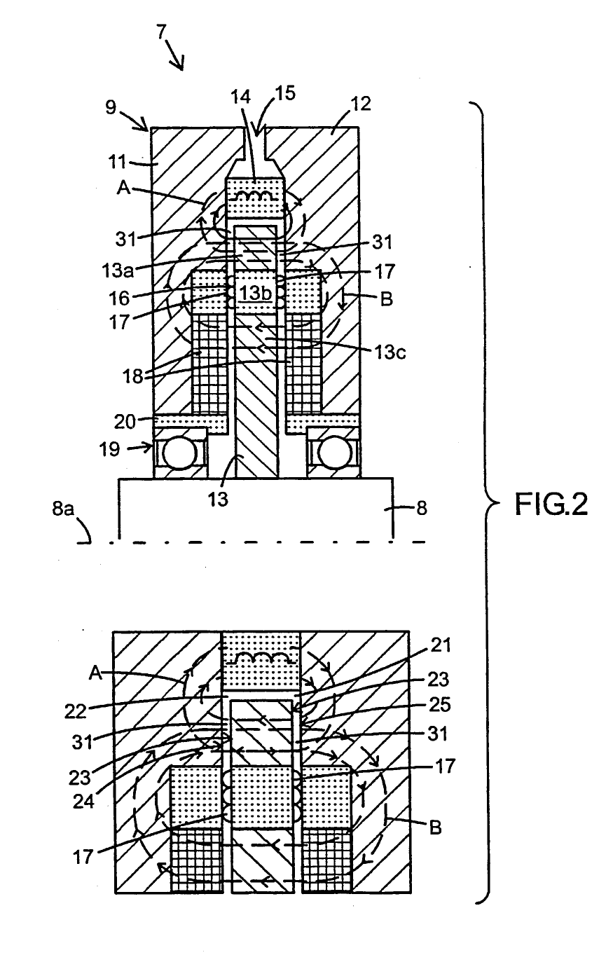

One embodiment of the invention comprises a brake system 7 that comprises a magnetic arrangement 10 consisting of two disc-shaped pole halves 11 and 12 arranged to be parallel to each other, which pole halves are manufactured from magnetic material (FIG. 2). The pole halves 11 and 12 are arranged radially and symmetrically one on each side of a disc-shaped rotor 13. A winding/coil 14 on a non-magnetic bobbin (not shown) is fixed arranged between the pole core halves 11 and 12 at a distance from the axis of symmetry 8a. The pole core halves 11 and 12 are designed such that a first air gap 15 is formed radially outside of the winding 14. The air gap 15 is designed to control a magnetic flux.

The rotor 13 is arranged radially inside the coil 14 and between the pole core halves 11 and 12. The disk-shaped rotor 13 is composed of three radial sections, two of them 13a and 13c are of magnetic material while between them is arranged a section of non-magnetic material 13b. Axial sealings 17 are built into the rotor 13 on both surfaces 16 of the section 13b of the rotor. The sealings 17 seal against the sections 11b and 12b of non- magnetic material arranged in the respective pole half 11 and 12. Permanent magnets 18 are arranged radially in the respective pole half between the section with non-magnetic material 11b, 12b and the bearings 19 of the respective pole half. A bush 20 of non-magnetic material is arranged between the pole halves 11 and 12 and the shaft 8. The sealings 17 on both sides of the rotor 13 limit a volume 21, whose limits are formed by the rotor, the pole halves and the coil. The volume 21 contains a magneto-rheological medium. The medium 22 is placed between one surface 23 on the respective side of the rotor 13 and a first surface 24 of the pole half 11 and a second surface 25 on the pole half 12, where it is caused to be activated to transfer a force F_{B} between the rotor and the respective pole half.

When a current passes through the coil a magnetic field A is produced that acts against the magnetic field B from the permanent magnets 12 (FIG. 2). When the magnetic fields A and B are equal in strength, the rotor can rotate freely. During a desired braking, the current through the coil is reduced, which means that the sum of the opposing magnetic fields gives a resulting magnetic field C and a retardation torque M_{C}, which is transferred to the rotor 13 and thus the shaft 8 via the activated medium 22. It is the surfaces 24/25 that constitute the active area of the active medium and that determine the magnitude of the retardation torque M_{C}.

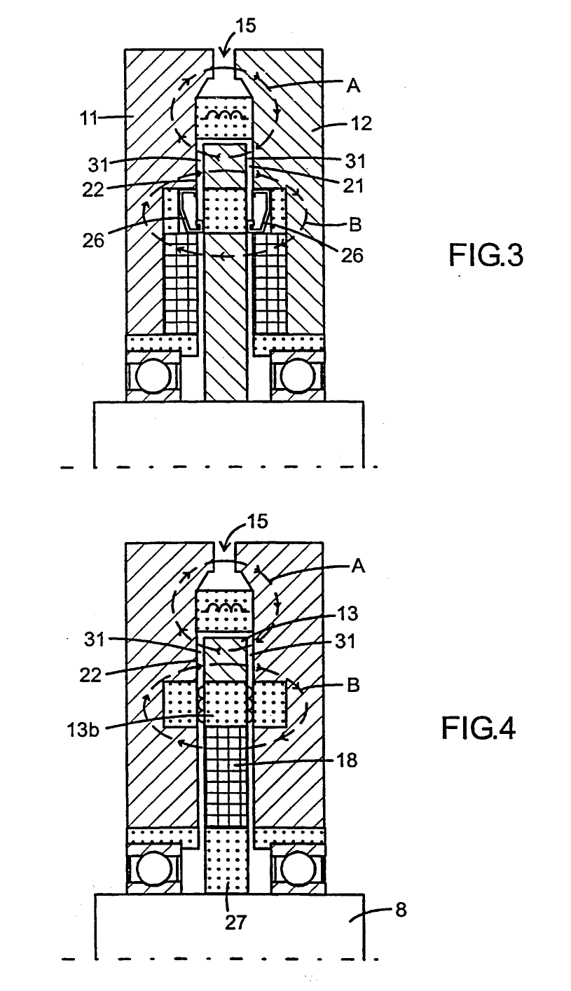

FIG. 3 shows another embodiment of the present invention in which the volume 21 of the medium 22 is limited by a sealing 26 built into the respective pole half 11 and 12. The brake system in FIG. 3 is otherwise the same as in the embodiment described above (FIG. 2) and functions in the same way. Thus, the active area is the same.

FIG. 4 shows a further embodiment of the present invention in which, based on the initial brake system shown in FIG. 2, the permanent magnets have been replaced by a single permanent magnet arranged in the rotor 13 between the section 13b of non-magnetic material and the shaft 8. A section 27 of non-magnetic material stretches radially between the shaft 8 and the permanent magnet 18. The active area of the medium is the same as those in the previously described embodiments.

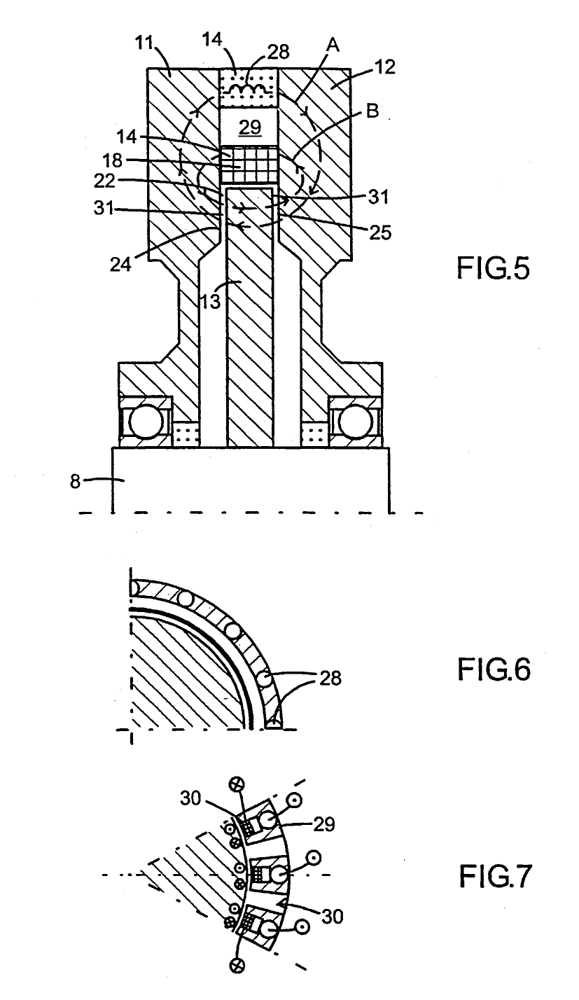

FIG. 5 shows an embodiment with two parallel pole halves that are axially connected by a number of axially oriented preferably small coils 28 arranged radially displaced from the shaft 8. A ring-shaped air gap 29 is inside of the coils 28 and after this, closer to the shaft 8, a ring-shaped permanent magnet 18 is fixed arranged between the pole halves. The rotor 13 is arranged radially inside of the permanent magnet 18. A magneto-rheological medium is activated between the surface 24 of the rotor and the surface 25 of the pole halves and the surfaces constitute the active area of the magneto-rheological medium. In this case there are no sealings since the magnetic field of the permanent magnet attracts the medium. The embodiment according to FIG. 5 is shown in radial cross-section in FIG. 6 with the axially oriented coils 28 built into a non-magnetic material. An alternative to the embodiment shown in FIG. 5 is shown in FIG. 7 in which a number of units 29 are arranged between the pole halves along their circumference and with an air gap 30 between them. Each unit 29 comprises a coil, permanent magnet 30 and sections of non-magnetic material. The permanent magnet has in this way been divided up into a number of parts.

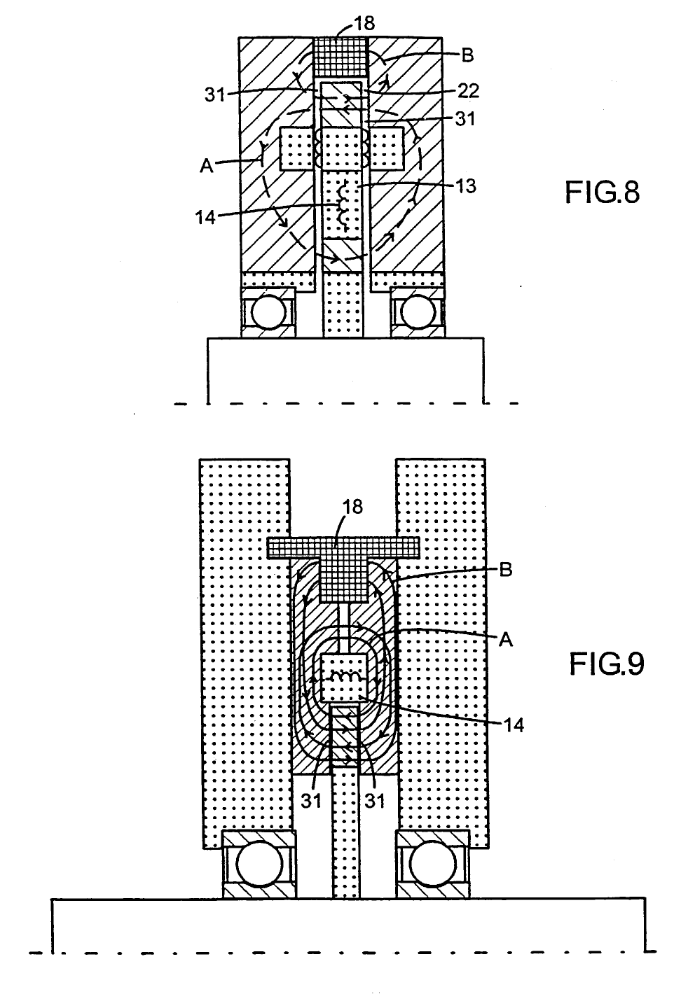

A permanent magnet device is arranged in the embodiment shown in FIG. 8 fixed arranged between the pole halves and along the circumference of the pole halves. A coil 14 is built into a rotor 13.

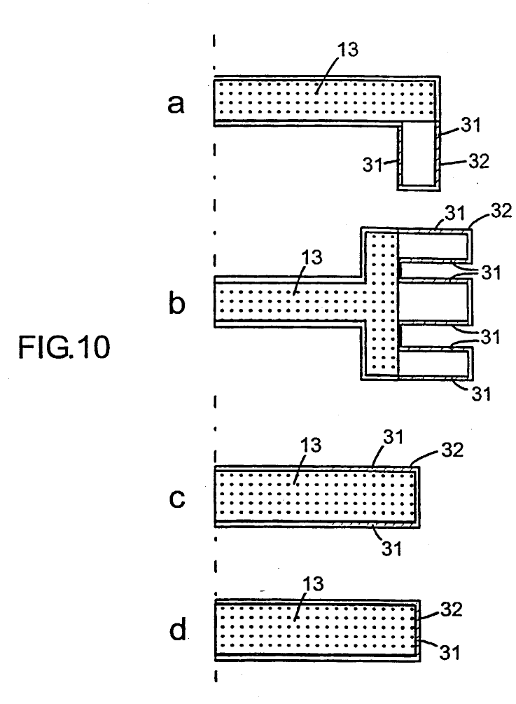

An air gap 15 is shown between the peripheral parts of the pole halves in FIGS. 2-4. The function of the air gap 15 here is to prevent short-circuiting of the permanent magnets and thus to force the magnetic field to pass through an active gap 31 that forms the active area 32 (see also FIG. 10c). The larger the size of the air gap, the stronger the coil that is required to overcome the air gap and in order to give a strongly opposing magnetic field in the active gap 31. No sealings are required in the embodiment that is shown in FIG. 5 since the magnetic field will always be strongest in the active gap 31 and thus the magnetic field holds the medium in place. A strong magnetic field is located inside of the active gap 31 in other embodiments, which may draw the medium 22 in the “wrong direction”, which is why sealings are needed.

The embodiments that have been shown above are based on the premise that the permanent magnets that are used can be demagnetised by the magnetic field of the coil. The embodiment that is shown in FIG. 9 is based on the permanent magnets 18 being hard and thus can be placed in serial with the coil 14 without them becoming demagnetised. In this case the coil 14 and the permanent magnet 18 have exchanged places when compared with their places in the embodiments shown in FIGS. 2-4. The air gap is located between the coil and the permanent magnet. The coil is wound as in FIGS. 2-4. The advantages of this embodiment are that only one coil is required and that no sealings are required.

The active gap 31 is formed by the active area 32, and its appearance can be modified if the magnetic fields are formed in an equivalent manner. The active gap 31 is otherwise formed in that the rotor is placed at an angle where the active gap 31 begins (FIG. 10a) or in that the rotor is divided into two or more rotors with active gaps 31 between them (FIG. 10b). The magnetic field is formed such that the active gap 31 lies on both sides of the rotor (FIG. 10c), or along the surface of the rotor (FIG. 10d). The strength of the required magnetic field increases with an increasing number of active gaps that the magnetic field is to bridge.

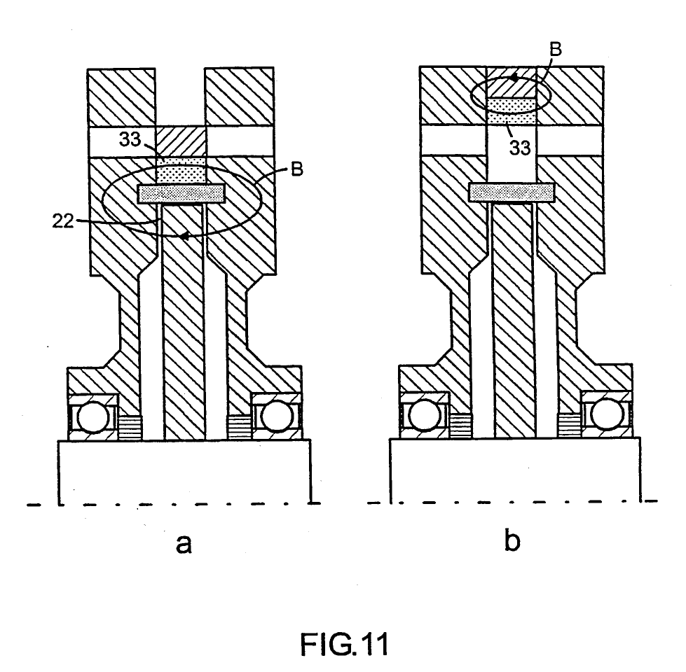

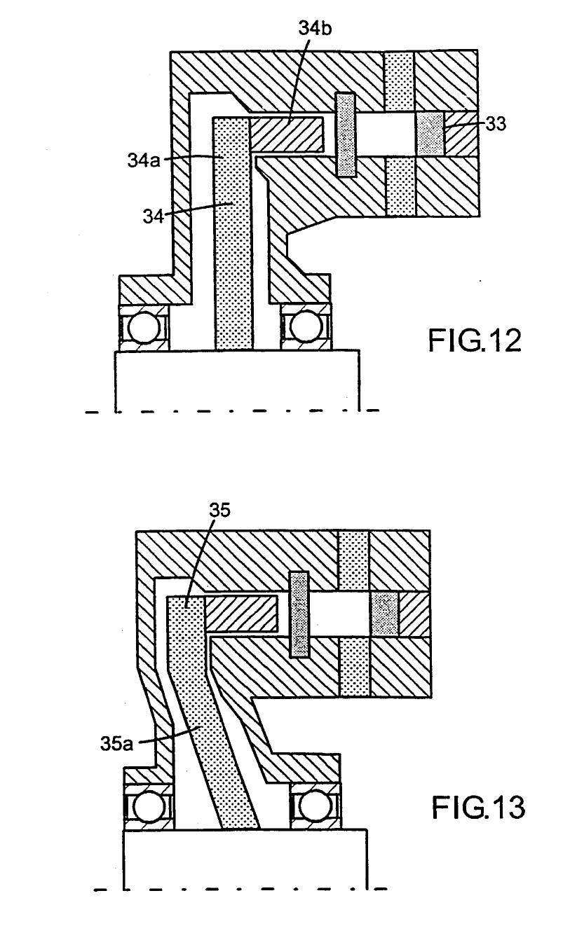

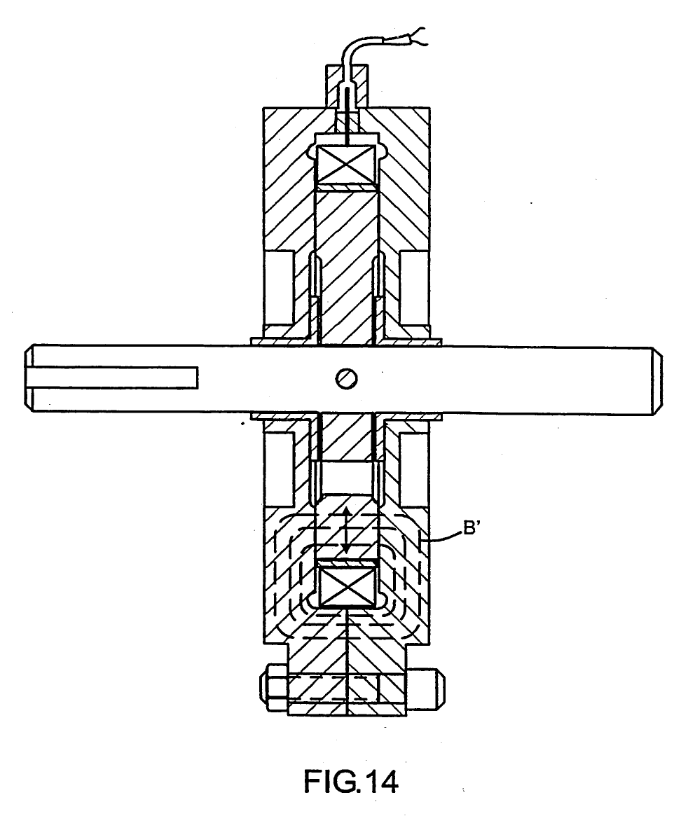

An embodiment is shown in FIG. 11 with a displaceably arranged permanent magnet 33. In this way, a magneto-rheological medium 22 can be activated without the requirement for a coil. FIG. 11a shows the permanent magnet 33 in a braking condition and FIG. 11b shows the permanent magnet in a passive, non-braking condition. Further embodiments with displaceably arranged permanent magnet are shown in FIGS. 12 and 13. A rotor 34 is placed at an angle in FIG. 12, and this rotor is constituted by a radial part 34a of non-magnetic material and an axial part 34b of magnetic material. The permanent magnet 33 is in a passive, non-braking position. A rotor 35 according to FIG. 12 is shown in FIG. 13 also placed at an angle in the radial non-magnetic section 35a. The permanent magnet is also here in the passive, non-braking position.

1. An industrial robot (1) including a manipulator (2) and a control system (3), which manipulator comprises a first robot part (4) and a second robot part (5) arranged displaceable relative to each other and a drive means (6) that brings about the movement between the robot parts characterised in that the driving means (6) comprises a brake system (7) regulatably arranged in collaboration with the control system (3), which braking system comprises a first body (11) with a first surface (24) and a second body (12) with a second surface (25) and that a medium (22) is arranged between the first surface (24) and the second surface (25), which medium transfers a force (F) between the bodies when in an active condition and that the braking system (7) comprises a magnetic arrangement (10) comprising at least one permanent magnet (18).

2. Industrial robot according to claim 1, characterised in that a magnetic field of the magnetic arrangement (10) comprised in the braking system (7) activates the medium (22).

3. Industrial robot according to claim 2, characterised in that the magnetic arrangement (10) comprises at least on current-carrying coil (14), the magnetic field of which is variable with the current.

4. Industrial robot according to claim 3, characterised in that the permanent magnet (18) is movable arranged in order to vary the magnetic field across the medium (22).

5. Industrial robot according to any one of the preceding claims, characterised in that the medium (22) comprises a fluid.

6. Industrial robot according to any one of the preceding claims, characterised in that the medium (22) is a MR-fluid.

7. Industrial robot according to any one of the preceding claims, characterised in that the first surface (24) and the second surface (25) are arranged to be parallel to each other.

8. Industrial robot according to claims 3-4, characterised in that a magnetic field (A) produced by the coil (14) and the magnetic field (B) of the permanent magnet (18) are opposed to each other.

9. Industrial robot according to claim 8, characterised in that the magnetic flux (A) from the coil is arranged directed such that the permanent magnet (18) retains its magnetisation.

10. A method for manufacturing an industrial robot (1) including a manipulator (2) and a control system (3), which manipulator comprises a first robot part (4) and a second robot part (5) arranged displaceable relative to each other and a drive means (6) that brings about the movement between the robot parts (4), (5) characterised in that the driving means (6) is caused to comprise a brake system (7) regulatably arranged in collaboration with the control system (3), that the brake system (7) is caused to comprise a first body (11) with a first surface (24) and a second body (12) with a second surface (25), and that a medium (22) is placed between the surfaces (24), (25), which medium is caused to be activated to transfer a force (F) between the bodies and that the braking system (7) is caused to comprise a magnetic device (10) comprising at least one permanent magnet (18).

11. Method according to claim 10, characterised in that the magnetic device (10) is caused to comprise at least one coil (14) and in that a current through the coil (14) generates a magnetic field (A).

12. A method for an industrial robot (1) including a manipulator (2) and a control system (3), which manipulator (2) comprises a first robot part (4) and a second robot part (5) arranged displaceable relative to each other and a drive means (6) that brings about the movement between the robot parts (4), (5), characterised in that the driving means (6) comprises a brake system (7) regulatably arranged in collaboration with the control system (3), that the brake system (7) comprises a first body (11) and a second body (12) and a medium (22) that combines the bodies (11), (12), that the medium (22) is activated by an magnetic field (A, B) generated by at least one permanent magnet (18) comprised in the brake system (7) whereby a force is transferred between the bodies such that the movements of the robot (1) are regulatably braked and brought to stop.

13. Method according to claim 12, characterised in that the robot parts (4), (5) are held in a stationary position.

14. Method according to claim 12 or 13, characterised in that the magnetic field is caused to comprise a first magnetic field (A) that is generated by a current-carrying coil (14) whereby the current is arranged to regulate the force.

15. Method according to any one of claims 12-14, characterised in that the magnetic field is caused to comprise a second magnetic field (B) that is generated by at least one permanent magnet (18) whereby a displacement of the permanent magnet (18) is arranged to regulate the force.

16. Method according to any one of claims 12-15, characterised in that the first magnetic field (A) is arranged in the opposite direction to the second magnetic field (B).

17. The use of a medium (22) that in an active condition transfers a force (F) in a brake system (7), the brake system (7) comprising at least one permanent magnet (18), in an industrial robot (1) in order to brake dynamically the movements of the robot and in order to hold a load stationary.

18. The use according to claim 17 whereby the medium (22) is magneto-rheological.

19. The use according to claim 17 or 18 whereby the brake system (7) is a MR-brake.
